(19) United States
(12) Patent Application Publication
(10) Pub. No.: US 2008/0136642 A1
(43) Pub. Date: Jun. 12, 2008

(54) Personal security system

(76) Inventor: Charles Michael Wise, Columbus, OH (US)

Correspondence Address: DAVID A. GREENLEE, P.O. BOX 340557, COLUMBUS, OH, 43234, US

(21) Appl. No.: 11/999,956

(22) Filed: Dec. 7, 2007

Related U.S. Application Data
(60) Provisional application No. 60/873,501, filed on Dec. 7, 2006.

(51) Int. Cl. G08B 13/14

(52) U.S. Cl. 340/572.1

(57) ABSTRACT

A personal security system monitors the location of objects, such as a billfold, purse, pen, camera, jewelry, and other personal items, relative to a transceiver, or base station, which may be housed in a cell phone, PDA or other item having a power supply. The base station generates an rf signal throughout a predetermined radius of operation. The items to be monitored all carry unique rf identification tags, which can be passive, active, or semi-passive, which are transponders that receive and acknowledge receipt of a signal to the base unit. The base station is passive while the monitored items are in the protected zone, but when an item is removed from, or moves out of, the protected zone, the acknowledgement signal is no longer received by the base unit. It will then provide an audible alarm, or other sensory signal to alert the user the object is no longer within the protected zone.

### RELATED APPLICATION

This application is a regular utility filing, and claims priority, of U.S. Provisional Patent Application Ser. No. 60/873,501, filed Dec. 7, 2006.

### FIELD OF THE INVENTION

This invention relates generally to personal security systems and, more particularly, to such a system that is portable and enables a user to monitor movement of a plurality of movable objects relative to a base unit.

### BACKGROUND OF THE INVENTION

There is a proliferation of expensive electronic and other items that a person may use regularly and are so frequently used that the person usually travels on business or pleasure with these devices in his possession. These devices include cell phones, MP3 devices, Blackberry and similar multi-purpose communication devices, laptop computers, watches, voice recorders, expensive pens, wallets, credit cards, sun or other glasses, etc. It is becoming more common for thieves to steal these items through “snatch and run”, diversionary and other tactics. It is also not uncommon for busy business travelers to become so engrossed in cell phone usage that they become less than diligent in monitoring the presence of these items, making it easier for thieves to steal these items.

Many of these items are relatively small and easily mislaid. In addition to theft of these items, it is not uncommon for a person to momentarily mislay one or more of these items, either due to absent-mindedness or inattention or distraction. To locate a lost cell phone, the person may just call the cell number and locate the ringing noise—if the phone is on and within hearing range. Other items are not currently similarly locatable.

Many systems exist to keep track of children or pets via GPS locating devices or having a parent-carried r-f monitor constantly track a child- or pet-carried emitter. There are many systems that sound an alarm upon unauthorized removal of merchandise from a store or warehouse. Recently, several attempts have been made to provide an item monitoring system to keep track of these items. One of these is disclosed in Published U.S. Patent Application No. 2002/0113705—Wallace, which includes a device attached to a monitored item that sounds an alarm when a motion sensor senses unauthorized motion, such a movement by a thief. Another embodiment has a portable remote unit mounted on a monitored object and a base unit. When the monitored unit moves a pre-set distance from the base unit, an alarm sounds. This disclosure provides a clumsy and crude partial solution to the problem of simply monitoring multiple items against theft.

There is a need for a simple, lightweight and portable system that enables monitoring of personal items against unauthorized movement or theft.

### SUMMARY OF THE INVENTION

One object of this invention is the provision of simple, lightweight and portable system that enables monitoring of personal items against unwanted or unauthorized movement or theft.

One recent innovation in the identification of items is the use of tiny radio frequency (rf) identification (rfid) tags which replace bar codes to commercially track items. Hitachi has recently introduced a passive rfid tag, called a p-chip that can be as small as 0.4 mm×0.4 mm. These chips have a 128-bit ROM for storing a unique 38 digit number, and have been used commercially to prevent ticket forgery at a technology exposition. Such a small size enables these chips to be unobtrusively applied to any item.

In one aspect, this invention generally features a personal security system which monitors the location of objects, such as a billfold, purse, pen, camera, jewelry and other personal items, relative to a transceiver, or base station, which may be housed in a cell phone, PDA or other personal communication device having a power supply. The base station generates an rf signal throughout a predetermined radius of operation. The items to be monitored all carry unique rf identification tags, which can be passive, active, or semi-passive, which are transponders that receive and acknowledge receipt of a signal to the base unit. The base station is passive while the monitored items are in the protected zone, but when an item is removed from, or moves out of, the protected zone, the acknowledgement signal is no longer received by the base unit. It will then provide an audible alarm, or other sensory signal to alert the user the object is no longer within the protected zone.

In another aspect, this invention features a personal security system for monitoring a plurality of personal items simultaneously, each of which carries a unique identifier, which incorporates the technology of a tiny rfid tag, to be monitored. A base or monitoring unit, attached to the power source of a conventional device, such as a cell phone or PDA, is programmable to monitor movement of each item relative to the monitoring unit. It is also specifically programmable to monitor only specific, identified items, so that several people having monitoring systems are not confused by the presence of the monitored items of the other persons. If movement is beyond a predetermined distance, which may be different for each monitored device, then a sensory signal, such as an alarm is sounded. A different audible or visible or tactile alarm signal can be used for different monitored items. The programming can accommodate any scheme that a user might desire.

In this way, the system provides a personal protected zone around the person carrying the cell phone or other monitoring device. Removal of a monitored item, either by theft, inadvertent dropping, leaving behind, or due to disaster or accident, will trigger an alarm identifying removal of the item from the personal security zone and identity of the removed item.

This system operates on the principle of relative movement of the base unit relative to one or more monitored items. Thus, if the base unit cell phone is inadvertently left behind, movement by the person away from the cell phone, while in possession of one or more of the monitored items, will effect a triggering of the alarm.

Other objects and features of this invention will become more readily apparent upon reference to the following detailed description of the invention, as depicted in the attached drawing, in which:

### BRIEF DESCRIPTION OF THE DRAWINGS

FIG. 1 is a schematic view of a personal security system, illustrating a base unit and monitored items, according to this invention; and

FIG. 2 is a schematic depiction of a user carrying a base unit and a variety of monitored protected zones—one for each monitored item.

### DETAILED DESCRIPTION OF THE PREFERRED EMBODIMENT

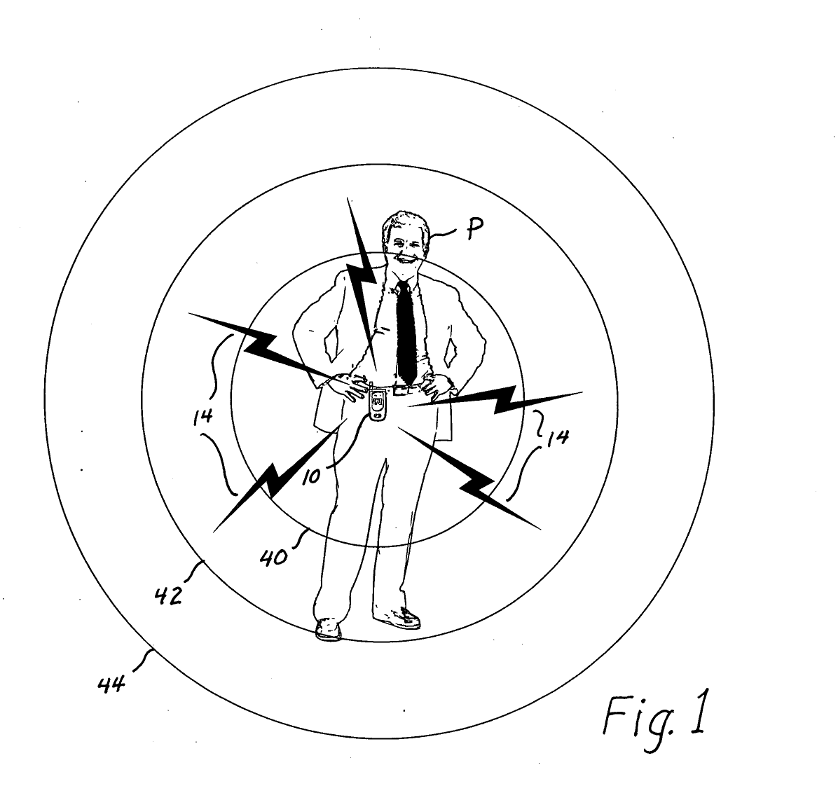

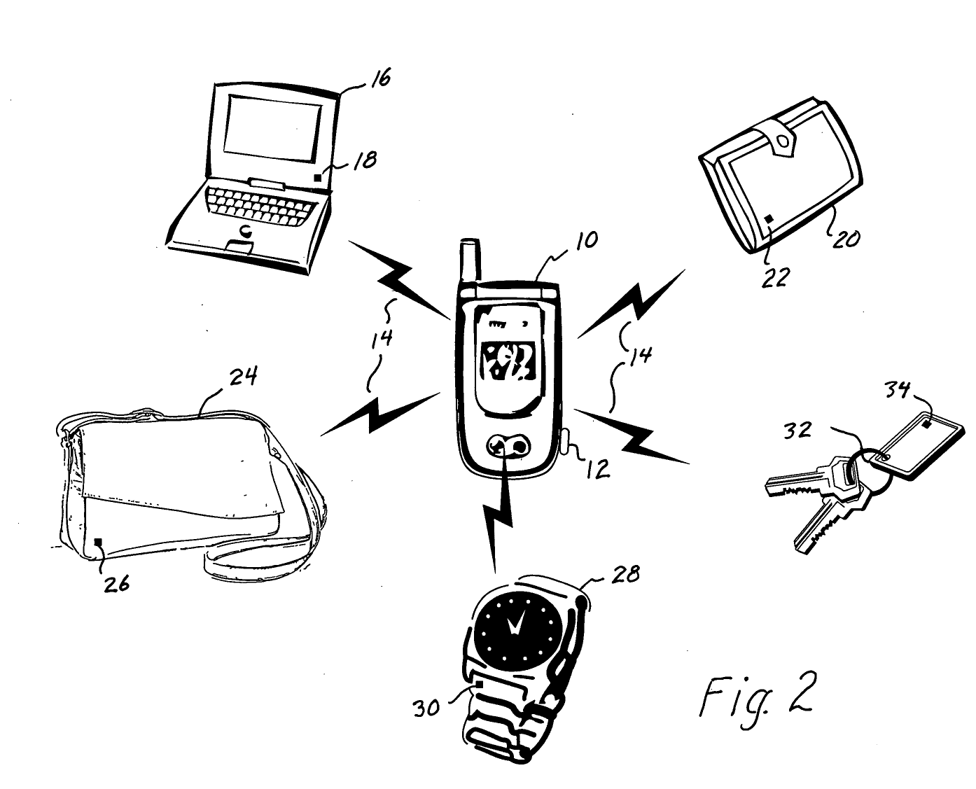

Referring now to both FIGS. 1 and 2, a person, or user P carries a conventional cell phone 10, which incorporates a monitoring unit 12 that is connected to the cell phone power system so that power is available to the monitoring unit, even when cell phone 10 is turned off. Unit 12 is a computer-on-a chip, and is thus quite small in size. It sends out RF signals 14 to the area surrounding cell phone 10.

A laptop 16 carries a very small, nearly unnoticeable identifier tag 18 to identify the laptop. Similarly, a wallet 20 carries an identifier tag 22, while a handbag 24 carries its own identifier tag 26. A watch 28 carries an identifier tag 30 and a key fob 32 carries an identifier tag 34. These tags or preferably passive, but can be semi-passive or active, depending on the size of the monitored zone desired for the particular object.

Other items which may need monitoring and could be included in the personal security system are briefcases and attaches, backpacks, jewelry, suitcases, musical instruments and cases, fur coats, money clips, passports, credit cards, guns, pill cases, eyeglasses, hats, and myriad electronic and other items that a person might deem worthy of protection against loss.

As shown in FIG. 1, a person P carries cell phone 10 that has monitoring unit 12. The monitoring unit may be set to monitor different critical distances, or protected zones, shown as circles 40, 42, 44, for several of the items shown in FIG. 2. If, say wallet 20 is removed beyond the protected zone delineated by monitored circle 42, monitoring unit 12 will emit a pre-programmed audible or visual signal indicating this fact. Then person P, being warned may take immediate steps to locate and retrieve the wallet. The reason for having programmable, different size monitored zones for different items is that different items have a different sized normal zone of usage. While a person is usually loathe to have his wallet removed more than an arm's length from his body, his laptop may be stationed at a desk and he may frequently move away from it some distance, say to another room or to the restroom, necessitating a longer distance for the laptop.

This personal security system of this invention is quite versatile since it is programmable. The signal from the monitoring unit may be continuous or intermittent, and may increase in intensity as the distance the item is moved away from the monitoring unit increases. All of the identifiers may be passive or powered or partially powered (semi-passive). To keep the system economical, the rfid tags could all be passive to keep the system cost within the reach of most users.

If all rfid tags are powered or partially so, each can act as a base unit itself, so that all identifier devices would interact with all or selected ones of the others. Thus, any of a combination of item movements could be programmed to trigger alarms. It is also envisioned that directional identification may be incorporated, so that the monitoring person would be quickly oriented to the direction of removal, to be immediately apprised of a theft.

In another aspect, this invention is readily adaptable for health and safety of a person. One of the identifier devices could be adapted to be a reader of vital signs and could be monitored continuously or intermittently, so that, upon a vital sign reaching a predefined limit, the monitor could signal the person. In the event that the person were incapacitated and could not terminate the alarm, the distress signal could then be automatically relayed via rf signal to some central master monitoring station. This could occur either directly or indirectly, via use of the cell phone or PDA or other communication device circuitry. The monitoring device carried by the person could also signal the person's location if equipped with a GPS or similar location capability. In this day of miniaturization, all of this circuitry could be easily packaged into a small device carried by a cell phone.

The system is extremely portable, potent, programmable, adaptable and effective in protecting the personal valuables of a person, no matter where the user travels, and is adaptable to various other uses, as indicated above. One skilled in the art may readily concoct other obvious variations and other embodiments of the invention disclosed herein and defined by the following claims.

I claim:

1. A personal security system for monitoring the location of a monitored object relative to a base station, comprising
means carried by said base station for generating an rf signal having a predetermined radius of operation to form a personal security zone around the base station,
an rf identification tag carried by said monitored object for generating an acknowledgment signal upon the receipt of said rf signal, and
means carried by said base station for detecting said acknowledgement signal and for providing a sensory signal when said acknowledgement is thereafter no longer detected, thus recognizing that said object is no longer within said personal security zone.

2. The personal security system of claim 1, wherein the rf identification tag is passive.

3. The personal security system of claim 1, wherein the rf identification tag is active or semi-passive.

4. The personal security system of claim 1, including a plurality of said monitored objects, each carrying an rf identification tag.

5. The personal security system of claim 2, wherein at least one of said monitored objects carries a unique rf identification tag different from the others, and the base station is programmable to provide a different personal security zone for the object carrying the unique rf identification tag.

6. The personal security system of claim 2, wherein each of said monitored objects carries a unique rf identification tag different from the others, and the base station is programmable to provide a different personal security zone for each object.

7. The personal security system of claim 1, wherein the base unit is a cell phone.

8. A portable personal security system for monitoring the location of a plurality of monitored objects carried by a user relative to a personal communication device, comprising
a base station mounted on and powered by said personal communication device for generating an rf signal having a predetermined radius of operation to form a personal security zone around the base station,
an rf identification tag carried by each said monitored object for generating a unique acknowledgment signal upon receipt of said rf signal, and
means carried by said base station for detecting said acknowledgement signals and for providing a sensory signal to said user when any of said acknowledgement signals is thereafter no longer detected, thus recognizing that a specified one of said objects has been removed from the personal security zone.

9. The portable security system of claim 8, wherein each rf identification tag is passive.

10. The portable security system of claim 9, wherein at least one of the rf identification tags is active to enable said one rf identification tag to detect the acknowledgement signals of the other rf identification tags.
